(19) United States
(12) Patent Application Publication
(10) Pub. No.: US 2023/0226546 A1
(43) Pub. Date: Jul. 20, 2023

(54) SAMPLE CARTRIDGES

(71) Applicant: LexaGene, Inc., Beverly, MA (US)

(72) Inventors: Manojkumar M. Nair, Burlington, MA (US); John Frederick Regan, Boxford, MA (US); Gregory A. Dale, Wayland, MA (US)

(73) Assignee: LexaGene, Inc., Beverly, MA (US)

(21) Appl. No.: 17/910,523

(22) PCT Filed: Mar. 3, 2021
(86) PCT No.: PCT/US2021/020580

§ 371 Date: Sep. 9, 2022

Related U.S. Application Data
(60) Provisional application No. 62/988,535, filed on Mar. 12, 2020.

(51) Int. Cl. B01L 3/00

(52) U.S. Cl. CPC B01L 3/502738; B01L 3/50273; B01L 2200/10; B01L 2300/0816; B01L 2300/0861; B01L 2400/0481

(57) ABSTRACT

The invention provides sample cartridges for processing samples. The sample cartridges comprise at least one fluidic channel. Each fluidic channel comprises a sample chamber, a lysis chamber, a binding chamber, a pre-amplification region, and an amplification region. The sample cartridges also comprise a waste line that is in fluidic connectivity with each fluidic channel. The sample cartridges can interface with a plurality of plungers that are capable of occluding at least one fluidic channel, waste line, and/or optional assay line to limit the transport of fluids into, out of, and/or along at least one fluidic channel by plunging. The invention also provides multi-channel sample cartridges, which are sample cartridges that comprise at least two fluidic channels. In addition, the sample cartridges can house fluids on the cartridge, off the cartridge, or some on the cartridge and some fluids off the cartridge.

### CROSS-REFERENCE TO RELATED APPLICATIONS

This application claims priority to U.S. Provisional Patent Application No. 62/988,535 filed Mar. 12, 2020. The foregoing application is hereby incorporated by reference in its entirety.

### FEDERALLY SPONSORED RESEARCH OR DEVELOPMENT

Not applicable.

### TECHNICAL FIELD

The invention generally relates to sample cartridges. The invention more specifically relates to sample cartridges for determining the presence or absence of one or more nucleic acids in a sample.

### BACKGROUND

There is currently a need to process many samples in a short period of time. The processing of samples involves a series of sample processing steps. The steps may occur on different instruments and include manual steps, both of which are time consuming and may increase the risks of contamination and exposure. In addition, processing of samples can consume large quantities of reagents and generate large amounts of waste.

Thus, there is a need for sample cartridges that overcomes the aforementioned problems and limitations.

### SUMMARY

The invention provides sample cartridges for processing samples. The sample cartridges comprise at least one fluidic channel. Each fluidic channel comprises a sample chamber, a lysis chamber, a binding chamber, a pre-amplification region, and an amplification region. The sample cartridges also comprise a waste line that is in fluidic connectivity with each fluidic channel and optionally at least one assay line that is in fluidic connectivity with the at least one fluidic channel.

The sample cartridges can interface with a plurality of plungers that are capable of occluding (including reversibly occluding) at least one fluidic channel, at least one waste line, and/or at least one optional assay line to limit the transport of fluids into, out of, and/or along at least one fluidic channel by plunging. The plurality of plungers can also be used to transport fluids into, out of, and/or along (through) at least one fluidic channel, at least one waste line, and/or at least one optional assay line by sliding (including rolling).

The sample cartridges can be disposable to reduce the risk of contamination and exposure. The invention also provides multi-channel sample cartridges, which are sample cartridges that comprise at least two fluidic channels. Multi-channel sample cartridges can process samples in parallel and therefore reduce overall processing times as compared to serial processing. In addition, multi-channel sample cartridges can reduce the amount of waste per sample as compared to single-channel sample cartridges. The sample cartridges can be fully integrated, meaning that all sample processing steps occur on (in) the sample cartridges. In preferred embodiments, the sample cartridges are fully integrated. In addition, the sample cartridges can house fluids (including reagents and assays) on the cartridge (in a fluid state or in a dry state, for example, lyophilized), fluids off the cartridge, or some fluids on the cartridge and some fluids off the cartridge. Waste that is generated during sample processing can remain on sample cartridges (for example, in one or more waste areas) so that waste never exits the sample cartridges. The sample cartridges can be designed to interface with a sample processing instrument that can automate one or more sample processing steps. In preferred embodiments, sample cartridges interface with a sample processing instrument that automates all sample processing steps. In addition, the sample cartridges are designed to consume low volumes of reagents. The sample cartridges are useful in a variety of fields including but not limited to clinical diagnostics, biotechnology, healthcare, food safety, and veterinary medicine for determining the presence or absence of one or more nucleic acids in a sample.

Unless otherwise defined, all terms used herein have the same meaning as commonly understood by a person having ordinary skill in the art to which the invention pertains. All patents, patent applications, publications, and other references mentioned herein and/or listed in the Application Data Sheet are hereby incorporated by reference in their entirety. In case of conflict, the specification will control. When a range of values is provided, the range includes the end values.

The materials, methods, components, features, embodiments, examples, and drawings disclosed herein are illustrative only and not intended to be limiting.

### DESCRIPTION OF DRAWINGS

The invention is best understood from the following detailed description when read in connection with the drawings disclosed herein, with similar elements having the same reference numbers. When a plurality of similar elements is present, a single reference number may be assigned to the plurality of similar elements with a small letter designation referring to at least one specific similar element. When referring to the similar elements collectively or to a non-specific similar element, the small letter designation may be dropped. The various features of the drawings may not be drawn to scale and may be arbitrarily expanded or reduced for clarity. Included in the drawings are the following figures:

FIG. 1A is a diagram of a single-channel sample cartridge in accordance with aspects of the invention.

FIG. 1B is a diagram of a cross-section view of the single-channel sample cartridge in FIG. 1A in accordance with aspects of the invention.

FIG. 2 is a diagram of the single-channel sample cartridge in FIG. 1A in accordance with aspects of the invention.

FIG. 3 is a diagram of a three-channel sample cartridge in accordance with aspects of the invention.

FIG. 4 is a flow diagram of the creation of reaction units in the three-channel sample cartridge of FIG. 3.

FIG. 5 is a diagram of a three-channel sample cartridge in accordance with aspects of the invention.

FIG. 6 is a flow diagram of the creation of reaction units in the three-channel sample cartridge of FIG. 5.

FIG. 7 is a diagram of a three-channel sample cartridge in accordance with aspects of the invention.

FIG. 8 is a flow diagram of the creation of reaction units in the three-channel sample cartridge of FIG. 7.

FIG. 9 is a diagram of a six-channel sample cartridge in accordance with aspects of the invention.

### DEFINITIONS

To facilitate understanding of the invention, a number of terms are defined herein.

“Assay unit” or “assay plug” means a mixture of primer(s) and probe(s) for amplifying at least one target region of at least one nucleic acid. An example of an assay unit is the primers and probe for amplifying at least one target region of at least one nucleic acid of the bacterium Escherichia coli.

“Carrier” means a fluid that is used to transport fluid(s) and/or separate two fluids. For example, carrier can be used to transport reaction units (for example, by pressure applied to the carrier) and/or separate two reaction units (to create two discrete reaction units). An example of a carrier is oil.

“Chain of reaction units” means reaction units separated by carrier to form a series of discrete reaction units.

“Master mix” means a mixture of reagents for a nucleic acid amplification reaction. Master mix typically includes buffer, divalent cations, polymerase and deoxynucleotides (dNTPs) (and/or similar nucleotides).

“Reaction unit” or “reaction plug” means a mixture of components including but not limited to sample, reagents, and assay.

“Reagent” means a substance that is not a sample or assay (or component of an assay).

“Sample mixture” means a mixture of sample and reagents. An example of a sample mixture is a mixture of sample and master mix.

### DETAILED DESCRIPTION

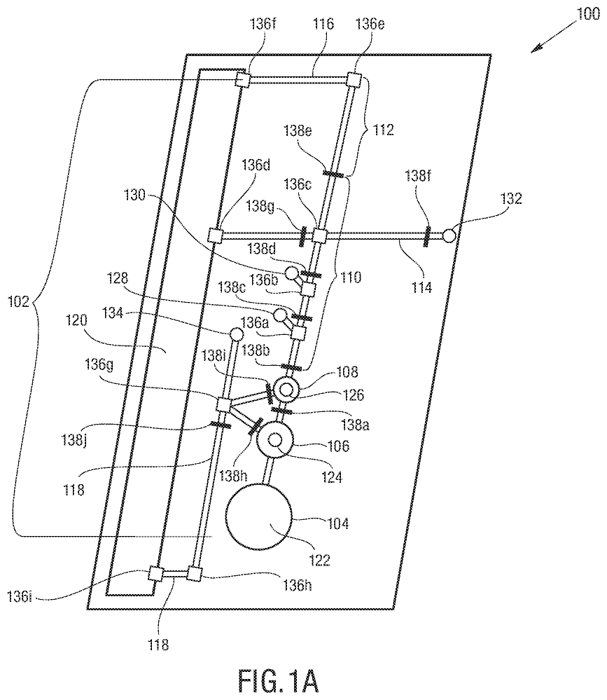

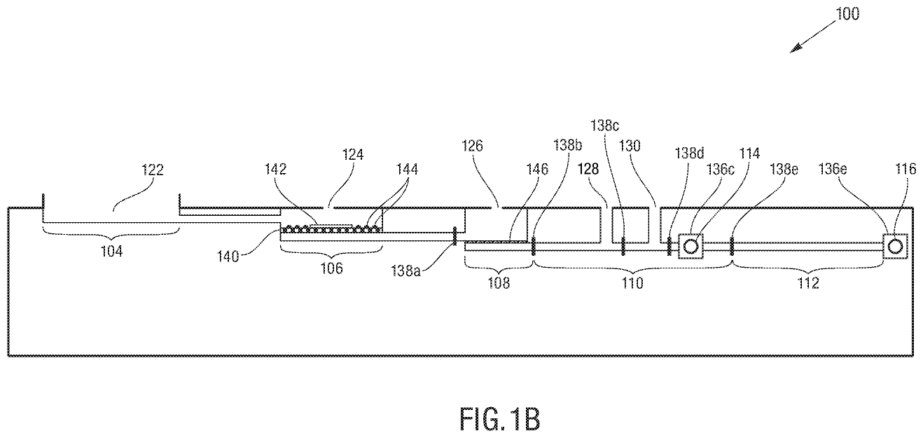

FIG. 1A is a diagram of a sample cartridge in accordance with aspects of the invention. The sample cartridge 100 is a one-channel sample cartridge comprising fluidic channel 102. Fluidic channel 102 comprises a sample chamber 104, a lysis chamber 106, a binding chamber 108, a pre-amplification region 110, and an amplification region 112.

The sample chamber 104 comprises a sample chamber port 122. The lysis chamber 106 comprises a filter 140 (depicted in FIG. 1B), a lysis chamber port 124, and a means for lysing (for example, a magnetic bar 142 and beads 144 depicted in FIG. 1B). The binding chamber 108 comprises a nucleic acid binding unit 146 (depicted in FIG. 1B) and a binding chamber port 126. The pre-amplification region 110 comprises a first pre-amplification region port 128 and a second pre-amplification region port 130.

Sample is transported along the fluidic channel 102 from the sample chamber 104 to the amplification region 112. The direction of sample transport creates an “upstream” and a “downstream” relevant to a reference point along fluidic channel 102. To be “upstream” from a reference point means to be closer to or at the sample chamber 104. To be “downstream” from a reference point means to be closer to or at the amplification region 112. For example, the lysis chamber 106 is upstream from the binding chamber 108. In this example, the binding chamber 108 is the reference point and the lysis chamber 106 is considered to be “upstream” relative to this reference point because the lysis chamber 106 is closer to the sample chamber 104. Conversely, the binding chamber 108 is downstream from the lysis chamber 106 because the binding chamber 108 is closer to the amplification region 112. For an additional example, the pre-amplification region 110 is downstream from the lysis chamber 106 and upstream from the amplification region 112.

In this embodiment, the sample cartridge 100 further comprises an assay line 114, a post-amplification waste line 116, a waste line 118, a waste area 120, junctions 136, and occlusion points 138.

The assay line 114 comprises an assay line port 132. The assay line 114 connects with the fluidic channel 102 at junction 136c and the waste area 120 at junction 136d. Post-amplification waste line 116 connects with the fluidic channel 102 at junction 136e and the waste area 120 at junction 136f. Waste line 118 comprises a waste line port 134. Waste line 118 connects with the fluidic channel 102 at lysis chamber 106 and binding chamber 108, both via junction 136g. The connection with the lysis chamber 106 is downstream from the filter 140, and the connection with the binding chamber 108 is downstream from the nucleic acid binding unit 146. The waste line has two sections that connect at junction 136h and connects with the waste area 120 at junction 136i.

In this embodiment, the lysis chamber port 124, binding chamber port 126, first pre-amplification region port 128, second pre-amplification region port 130, and waste line port 134 are connected to a first valve (not depicted). Each aforementioned port on sample cartridge 100 is connected to a different port on the first valve. The first valve is connected to a first pump (not depicted). The assay line port 132 is connected to a second valve (not depicted). The second valve is connected to a second pump (not depicted).

To use sample cartridge 100, a sample comprising cells is inserted (loaded) into sample chamber 104 through sample chamber port 122 using, for example, a pipette.

To transport the sample to the lysis chamber 106, occlusion points 138a, 1381, and 138j are closed, and occlusion point 138h is open. Suction is created at waste port 130 (using the first valve and first pump) and the sample is transported (pulled) into lysis chamber 106, through the filter 140, and into waste line 118. As the sample is pulled through the filter 140, the cells are captured on the filter 140. The remainder of the sample, which is waste, is transported into waste line 118 through junction 136g. Occlusion point 138h is closed, and occlusion point 138j is opened. Pressure is created at waste port 130 and the waste in waste line 118 is transported (pushed) through junctions 136h and 1361 to waste area 120.

To lyse the captured cells, occlusion points 138h, 138j, and 138b are closed, and occlusion points 138a and 138i are opened. Lysis buffer is inserted into the lysis chamber 106 through lysis chamber port 124. The lysis buffer mixes with the captured cells, and the cells are lysed using a means for lysing to create a lysate.

To transport the lysate to the binding chamber 108, occlusion point 138l is opened, and occlusion point 138j is closed. Suction is created at waste port 130 and the lysate is pulled into the binding chamber 108, through the nucleic acid binding unit 146, and into waste line 118. (The suction at waste port 130 pulls past occlusion points 138a and 138l.) As the sample is pulled through the nucleic acid binding unit 146, the nucleic acids of the lysed cells are captured on the nucleic acid binding unit 146. The remainder of the lysate, which is waste, is pulled into waste line 118 past occlusion point 138l and through junction 136g. Occlusion point 138l is closed, and occlusion point 138j is opened. Pressure is created at waste port 130 and the waste in waste line 118 is pushed through junctions 136h and 1361 to waste area 120.

To wash the nucleic acids, occlusion points 138a, 138b, 138h, and 138j are closed, and occlusion point 138l is opened. Wash buffer is inserted into the binding chamber 108 through binding chamber port 126. Suction is created at waste port 130 and the wash buffer is pulled through the nucleic acid binding unit 146, and into waste line 118. (The suction at waste port 130 pulls past occlusion points 138l.) Occlusion points 138l and 138h are closed, and occlusion point 138j is opened. Pressure is created at waste port 130 and the waste in waste line 118 is pushed through junctions 136h and 1361 to waste area 120.

To elute the nucleic acids, occlusion points 138a and 138b are closed, and occlusion point 138l is opened. Elution buffer is pumped to and positioned at binding chamber port 126. Occlusion point 138d is opened. Master mix (followed by carrier) is pumped to and positioned at the second pre-amplification region port 130. Occlusion point 138c is closed, and occlusion point 138b is opened. Carrier is pumped through the first pre-amplification region port 128 and positioned at the nucleic acid binding unit 146 (downstream side). Occlusion point 138l is closed, and occlusion point 138c is opened. Elution buffer is pumped into the binding chamber 108 through binding chamber port 126 until the elution buffer reaches junction 136b. Occlusion point 138b is closed. Additional carrier is pumped through the first pre-amplification region port 128 until the eluate is pushed to and positioned at junction 136b.

To mix the eluate with the master mix (and thereby create a sample mixture), additional carrier is pumped through the first pre-amplification region port 128, and master mix is pumped through the second pre-amplification region port 130 until the sample is mixed with the master mix and the sample mixture is positioned at junction 136c.

To mix the sample mixture with an assay unit (and thereby create a reaction unit), occlusion points 138d and 138e are closed, and occlusion points 138f and 138g are opened. An assay unit is pumped through the assay line 114 until it is at junction 136c. Occlusion point 138g is closed, and occlusion points 138d and 138e are opened. Carrier is pumped through first pre-amplification region port 128 to push and mix the sample mixture with an assay unit (in junction 136c) to create a reaction unit in junction 136c. Occlusion point 138d is closed. An assay unit is pumped through assay line 114 (through open occlusion point 138f) to push the reaction unit towards (and eventually into) the amplification region 112. In preferred embodiments, the previous steps (starting with closing occlusion points 138d and 138e) are repeated at least one time (using the remaining sample mixture and an additional assay unit) to create at least one additional reaction unit upstream from the previous reaction unit (and separated by carrier). The previous steps can be repeated 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 40, 50, 60, 70, 80, 90, 100, or more times to create a chain of reaction units with 2, 3, 4, 5, 6, 7, 8, 9, 10, 11, 12, 13, 14, 15, 16, 17, 18, 19, 20, 21, 22, 23, 24, 25, 26, 27, 28, 29, 30, 40, 50, 60, 70, 80, 90, 100, or more reaction units. After some or all of the reaction units are in the amplification region 112, the reaction units are amplified.

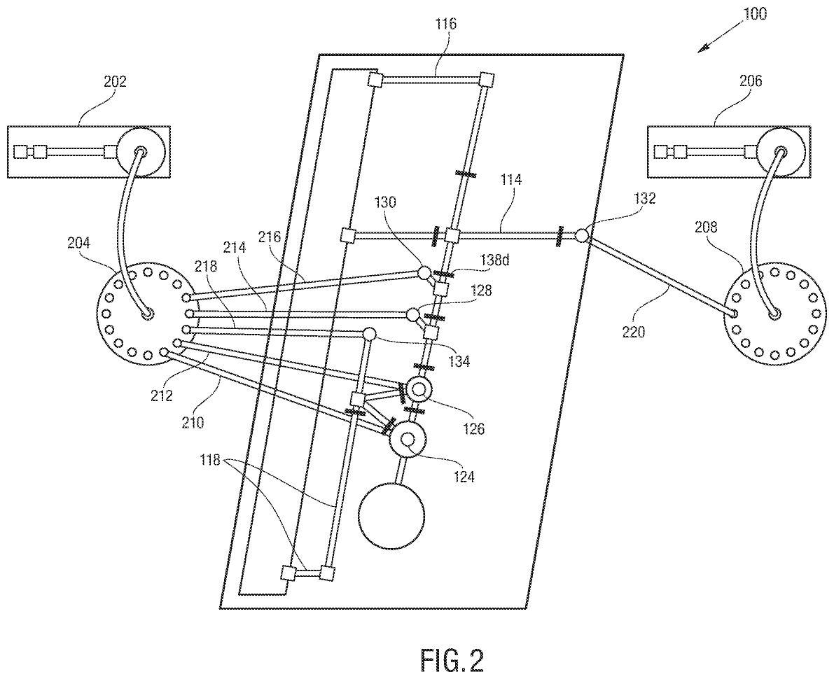

FIG. 2 is a diagram of the sample cartridge in FIG. 1A in accordance with aspects of the invention. In this embodiment, the sample cartridge 100 is connected to a pump 202 via a valve 204 and a pump 206 via a valve 208. The valve 204 is connected to the lysis chamber port 124 via tube 210, the binding chamber port 126 via tube 212, the first pre-amplification region port 128 via tube 214, the second pre-amplification region port 130 via tube 216, and the waste line port 134 via tube 218. The valve 208 is connected to the assay line port 132 via tubing 220.

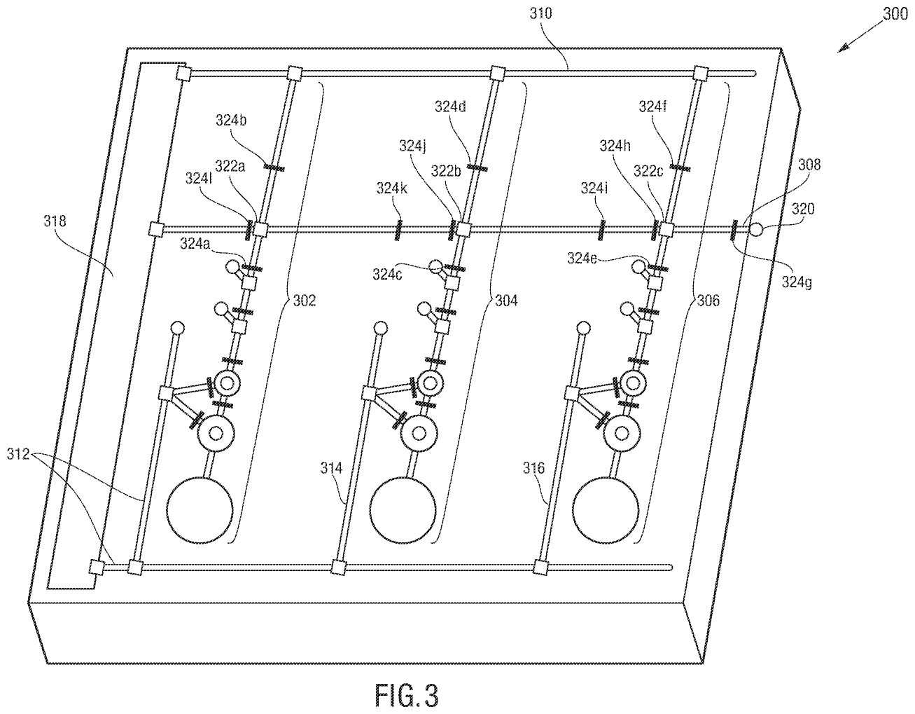

FIG. 3 is a diagram of a sample cartridge in accordance with aspects of the invention. The sample cartridge 300 is a three-channel sample cartridge comprising a first fluidic channel 302, a second fluidic channel 304, and a third fluidic channel 306. In this embodiment, the sample cartridge 300 further comprises an assay line 308, a post-amplification waste line 310, a first waste line 312, a second waste line 314, a third waste line 316, and a waste area 318. Each fluidic channel has a waste line that, in this embodiment, connects to one another and then to waste area 318. In this embodiment, the three fluidic channels share the single assay line 308. Fluids are not depicted in FIG. 3.

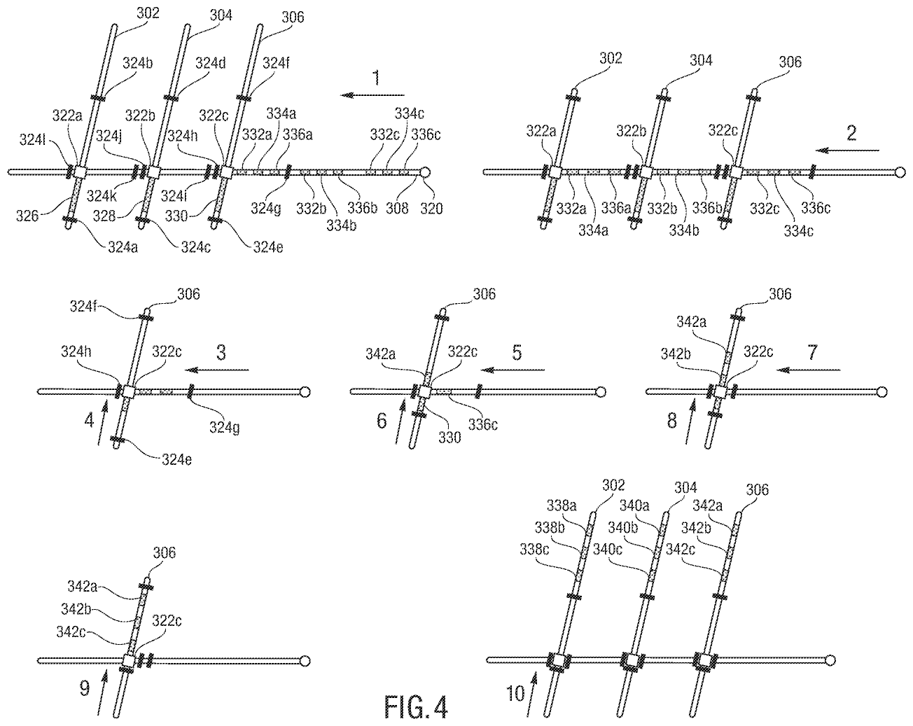

FIG. 4 is a flow diagram of the creation of reaction units in the three-channel sample cartridge of FIG. 3. This figure displays a section of the sample cartridge 300 including a section of first fluidic channel 302, a section of second fluidic channel 304, a section of third fluidic channel 306, and assay line 308.

In this embodiment, three first fluidic channel reaction units 338 (338a, 338b, and 338c), three second fluidic channel reaction units 340 (340a, 340b, and 340c), and three third fluidic channel reaction units 342 (342a, 342b, and 342c) are created in parallel. The reaction units are created by mixing first assay units 332 (332a, 332b, and 332c), second assay units 334 (334a, 334b, and 334c), and third assay units 336 (336a, 336b, and 336c) with first fluidic channel sample mixture 326, second fluidic channel sample mixture 328, and third fluidic channel sample mixture 330, respectively. Each of the three sample mixtures is initially one mass (bolus) that is split (separated by carrier) during the creation of reaction units such that each reaction unit is a mixture of some of the sample mixture and an assay unit.

In this embodiment, first fluidic channel reaction units 338 (338a, 338b, and 338c), second fluidic channel reaction units 340 (340a, 340b, and 340c), and third fluidic channel reaction units 342 (342a, 342b, and 342c) are created in 10 steps. Prior to step 1, three sets of the three assay units (one from first assay units 332, one from second assay units 334, and one from third assay units 336) are pumped to the assay line 308. The creation of the three sets of three assay units (with each set and each assay unit separated by carrier) is not depicted, but a person having ordinary skill in the art will understand that they can be created using a pump(s) and a valve(s) (and tubing). In this embodiment, the assay line 308 is connected to a pump(s) and a valve(s) (not depicted) via assay line port 320. In step 1, occlusion points 324l, 324k, 324j, 324i, 324h, and 324g are opened, and occlusion points 324b, 324d, and 324f are closed. In step 2, the three sets of three assay units (332a, 334a, and 336a; 332b, 334b, and 336b; and 332c, 334c, and 336c) are pumped so that the first assay unit of each set (i.e., 332a, 332b, and 332c) are adjacent to junctions 322a, 322b, and 322c, respectively. For steps 3 through 9, only third fluidic channel 306 is depicted. In step 3, occlusion points 324b, 324d, and 324f are opened, and occlusion points 324l, 324k, 324j, 324i, 324h, and 324g are closed. The plungers that plunge at occlusion points 324k, 324i, and 334g occlude and also slide (including roll) towards junctions 322a, 322b, and 322c, respectively. The sliding (including rolling) action pushes the leading edge of assay units 332a, 332b, and 332c into junctions 322a, 322b, and 322c, respectively. In step 4, the plungers that plunge at occlusion points 324a, 324c, and 324e occlude and also slide towards junctions 322a, 322b, and 322c, respectively. The sliding action pushes first fluidic channel sample mixture 326, second fluidic channel sample mixture 328, and third fluidic channel sample mixture 330 into junctions 322a, 322b, and 322c, respectively, where the sample mixtures begin to contact and mix with first assay units 332a, 332b, and 332c, respectively. In step 5, the plungers at 324k, 324i, and 334g slide towards junctions 322a, 322b, and 322c, respectively, to continue to contact and mix first fluidic channel sample mixture 326, second fluidic channel sample mixture 328, and third fluidic channel sample mixture 330 with 332a, 332b, and 332c, respectively. As the plungers at 324k, 324i, and 334g slide, first fluidic channel reaction unit 338a, second fluidic channel reaction unit 340a, and third fluidic channel reaction unit 342a are created and pushed downstream in first fluidic channel 302, second fluidic channel 304, and third fluidic channel 306, respectively. The carrier that was present between the first assay unit and the second assay unit of each of the three sets of assay units now separates reaction units 338a, 340a, and 342a from the sample mixtures in the respective fluidic channels. In step 6, step 4 is repeated. In step 7, step 3 is repeated. In step 8, step 4 is repeated. In step 9, step 3 is repeated with the remaining assay units (and sample mixtures) to create nine reaction units (three first fluidic channel reaction units 338 (338a, 338b, and 338c), three second fluidic channel reaction units 340 (340a, 340b, and 340c), and three third channel reaction units 342 (342a, 342b, and 342c)), all of which are depicted in step 10. In step 10, occlusion points 324a, 324c, and 324e are opened and the nine reaction units are pushed downstream towards the amplification region of each fluidic channel (not depicted) by carrier pumped in through the second pre-amplification region port of each fluidic channel (not depicted).

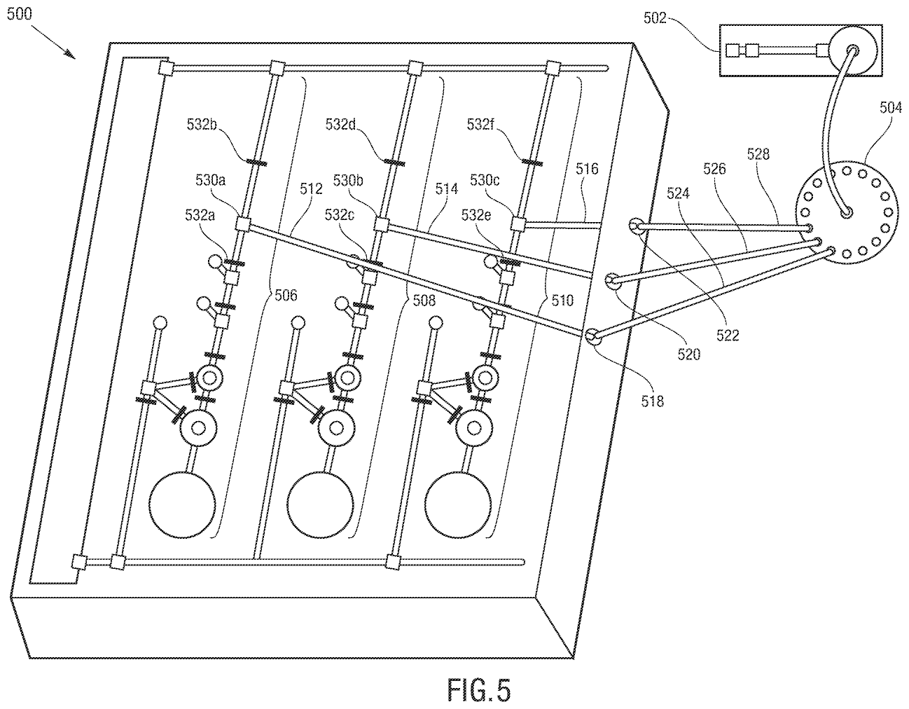

FIG. 5 is a diagram of a three-channel sample cartridge in accordance with aspects of the invention. In this embodiment, the sample cartridge 500 is connected to a pump 502 via a valve 504 and an additional pump and valve (not depicted). The sample cartridge 500 is a three-channel sample cartridge comprising a first fluidic channel 506, a second fluidic channel 508, and a third fluidic channel 510. In this embodiment, the sample cartridge 500 further comprises a first assay line 512 connected to the first fluidic channel 506, a second assay line 514 connected to the second fluidic channel 508, and a third assay line 516 connected to the third fluidic channel 510. The valve 504 is connected to first assay line 512 via first assay line port 518 and tubing 524, second assay line 514 via second assay line port 520 and tubing 526, and third assay line 516 via third assay line port 522 and tubing 528. Unlike the embodiment in FIG. 3, each fluidic channel is connected to a dedicated assay line that connects to a different port on valve 504. Fluids are not depicted in FIG. 5.

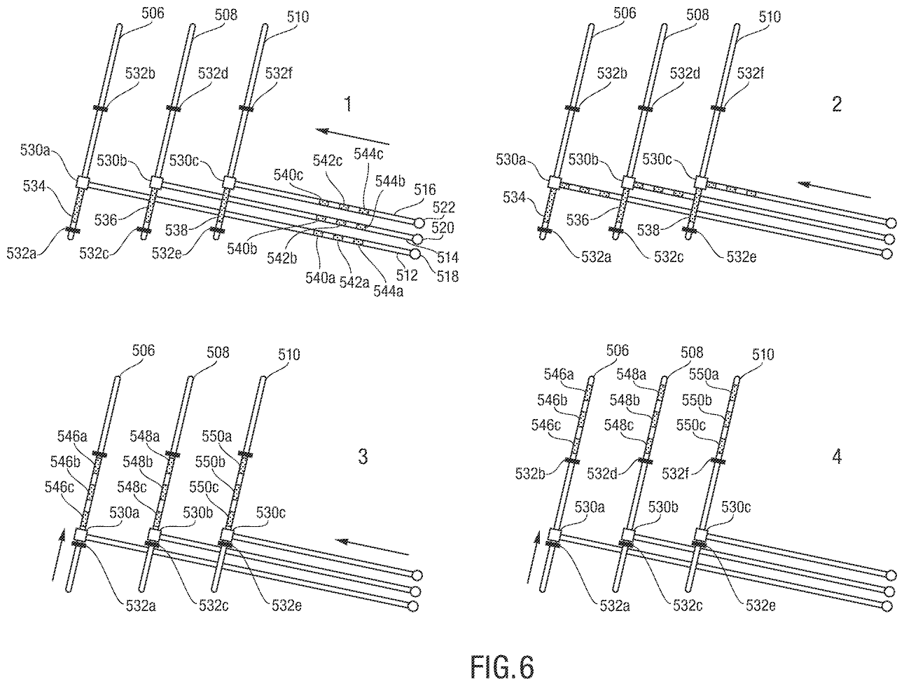

FIG. 6 is a flow diagram of the creation of reaction units in the three-channel sample cartridge of FIG. 5. This figure displays a section of the sample cartridge 500 including a section of first fluidic channel 506, a section of second fluidic channel 508, a section of third fluidic channel 510, first assay line 512, second assay line 514, and third assay line 516.

In this embodiment, three first fluidic channel reaction units 546 (546a, 546b, and 546c), three second fluidic channel reaction units 548 (548a, 548b, and 548c), and three third fluidic channel reaction units 550 (550a, 550b, and 550c) are created in parallel. The reaction units are created by mixing first assay units 540 (540a, 540b, and 540c), second assay units 542 (542a, 542b, and 542c), and third assay units 544 (544a, 544b, and 544c) with first fluidic channel sample mixture 534, second fluidic channel sample mixture 536, and third fluidic channel sample mixture 538, respectively. Each of the three sample mixtures is initially one mass (bolus) that is split (separated by carrier) during the creation of reaction units such that each reaction unit is a mixture of some of the sample mixture and an assay unit.

In this embodiment, first fluidic channel reaction units 546 (546a, 546b, and 546c), second fluidic channel reaction units 548 (548a, 548b, and 548c), and third fluidic channel reaction units 550 (550a, 550b, and 550c) are created in 4 steps. Prior to step 1, three sets of the three assay units (one from first assay units 540, one from second assay units 542, and one from third assay units 544) are pumped to first assay line 512, second assay line 514, and third assay line 516, respectively. The creation of the three sets of three assay units (with each set and each assay unit separated by carrier) is not depicted, but a person having ordinary skill in the art will understand that they can be created using pump 502 and valve 504 (and, optionally, additional pump(s) and/or valve(s) (and tubing)).

In step 1, occlusion points 532b, 532d, and 532f are opened. The three sets of the three assay units are pumped, one set through first assay line 512 via first assay line port 518, one set through second assay line 514 via second assay line port 520, and one set through third assay line 516 via third assay line port 522. In step 2, the three sets of three assay units (540a, 542a, and 544a; 540b, 542b, and 544b; and 540c, 542c, and 544c) are pumped so that the first assay unit of each set (i.e., 540a, 540b, and 540c) are adjacent to junctions 530a, 530b, and 530c, respectively. The plungers that plunge at occlusion points 532a, 532c, and 532e occlude and also slide (including roll) towards junctions 530a, 530b, and 530c, respectively. The sliding (including rolling) action pushes the leading edge of first sample mixture 534, second sample mixture 536, and third sample mixture 538 into junctions 530a, 530b, and 530c, respectively. As the sample mixtures and assay units mix in junctions 530a, 530b, and 530c, reaction units are created and pushed downstream towards the amplification region of each fluidic channel. In step 3, assay units and sample mixtures are optionally pushed until all of each sample mixture has been consumed to create reaction units, which, in FIG. 6, is three reaction units per fluidic channel (reaction units 546a, 546b, and 546c in first fluidic channel 506; reaction units 548a, 548b, and 548c in second fluidic channel 508; and reaction units 550a, 550b, and 550c in third fluidic channel 510). In step 4, occlusion points 532a, 532c, and 532e are opened. The nine reaction units are pushed into the amplification regions of the fluidic channels (not depicted) by carrier pumped in through the second pre-amplification region port of each fluidic channel (not depicted).

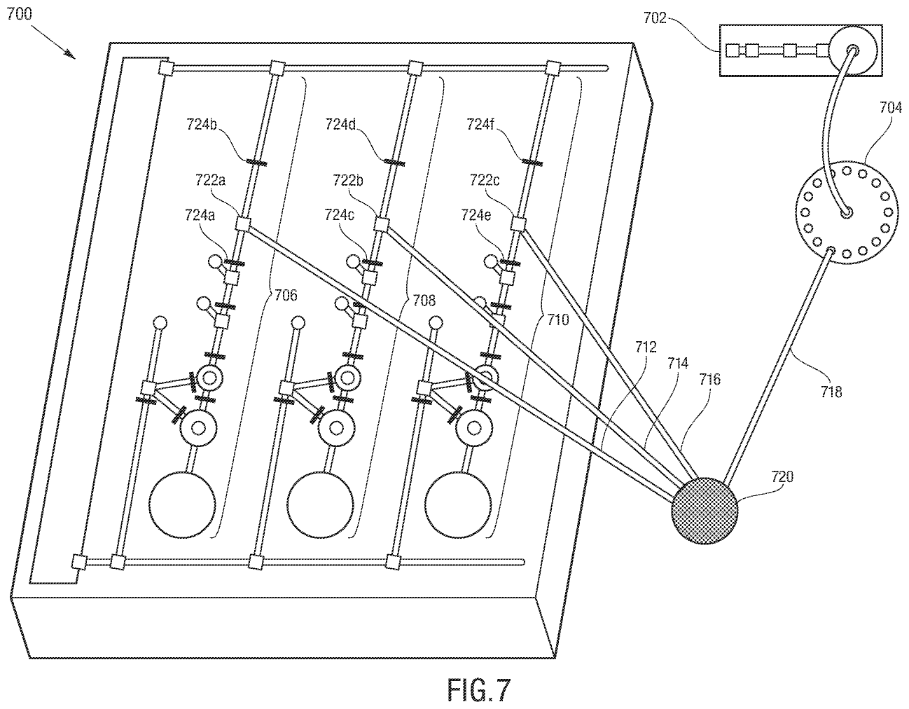

FIG. 7 is a diagram of a three-channel sample cartridge in accordance with aspects of the invention. In this embodiment, the sample cartridge 700 is connected to a pump 702 via a valve 704 and an additional pump and valve (not depicted). The valve 704 is connected to first fluidic channel 706, second fluidic channel 708, and third fluidic channel 710 via first assay line 712, second assay line 714, and third assay line 716, respectively. A splitter 720 is located between the valve 704 and the sample cartridge 700. The splitter 720 splits assays (that are pumped in by pump 702 via valve 704) into three assay units, one for each fluidic channel. Unlike the embodiments in FIG. 3 and FIG. 5, each fluidic channel is connected to an assay line that connects to splitter 720, and a tube 718 connects the splitter 720 to a port on valve 704. Fluids are not depicted in FIG. 7.

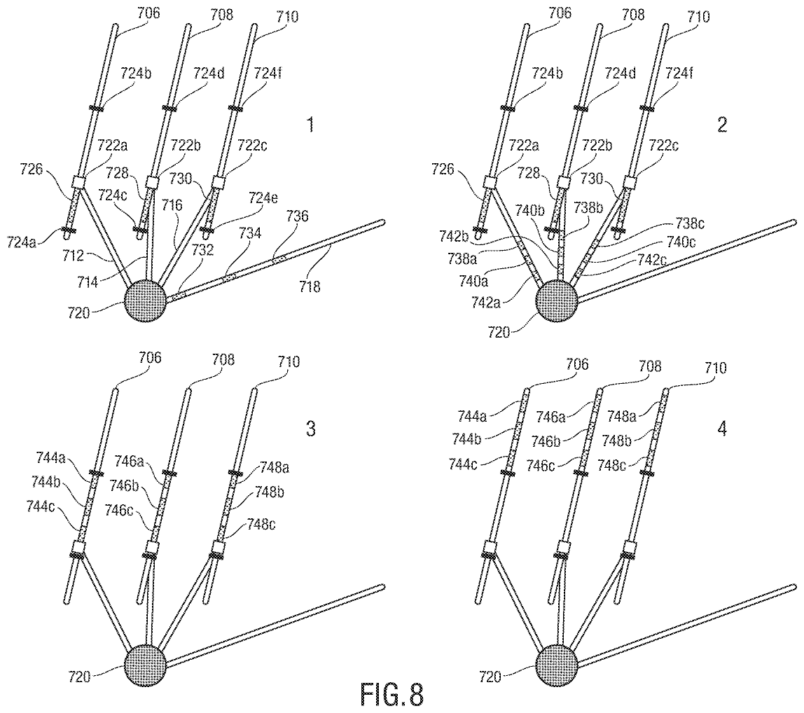

FIG. 8 is a flow diagram of the creation of reaction units in the three-channel sample cartridge of FIG. 7. This figure displays a section of the sample cartridge 700 including a section of first fluidic channel 706, a section of second fluidic channel 708, a section of third fluidic channel 710, first assay line 712, second assay line 714, and third assay line 716. This figure also displays the splitter 720 and tube 718.

In this embodiment, three first fluidic channel reaction units 744 (744a, 744b, and 744c), three second fluidic channel reaction units 746 (746a, 746b, and 746c), and three third fluidic channel reaction units 748 (748a, 748b, and 748c) are created in parallel. The reaction units are created by mixing first assay units 738 (738a, 738b, and 738c), second assay units 740 (740a, 740b, and 740c), and third assay units 742 (742a, 742b, and 742c) with some of first fluidic channel sample mixture 726, some of second fluidic channel sample mixture 728, and some of third fluidic channel sample mixture 730, respectively. First assay units 738 (738a, 738b, and 738c), second assay units 740 (740a, 740b, and 740c), and third assay units 742 (742a, 742b, and 742c) are created when first assay 732, second assay 734, and third assay 736 are split by the splitter 720, respectively. Each of the three assays is initially one mass that is split to create assay units.

In this embodiment, first fluidic channel reaction units 744 (744a, 744b, and 744c), second fluidic channel reaction units 746 (746a, 746b, and 746c), and third fluidic channel reaction units 748 (748a, 748b, and 748c) are created in 4 steps. Prior to step 1, first assay 732, second assay 734, and third assay 736 are created and pumped into tube 718. The creation of the three assays (with each assay separated by carrier) is not depicted, but a person having ordinary skill in the art will understand that they can be created using pump 702 and valve 704 (and, optionally, additional pump(s) and/or valve(s) (and tubing)). In step 1, occlusion points 724b, 724d, and 724f are opened. First assay 732, second assay 734, and third assay 736 are pumped to splitter 720. In step 2, first assay 732, second assay 734, and third assay 736 are pumped through splitter 720 where they are split into assay units as they are channeled (directed) to first assay line 712, second assay line 714, and third assay line 716. Each assay is split into three parts (three assay units) and one unit is channeled to each of the three assay lines. For example, first assay 732 is split into first assay units 738a, 738b, and 738c, and first assay unit 738a is channeled to first assay line 712, first assay unit 738b is channeled to second assay line 714, and first assay unit 738c is channeled to third assay line 716. The three sets of three assay units (738a, 740a, and 742a; 738b, 740b, and 742b; and 738c, 740c, and 742c) are pumped so that the first assay unit of each set (i.e., 738a, 738b, and 738c) are adjacent to junctions 722a, 722b, and 722c, respectively. The plungers that plunge at occlusion points 724a, 724c, and 724e occlude and also slide towards junctions 722a, 722b, and 722c, respectively. The sliding action pushes the leading edge of first fluidic channel sample mixture 726, second fluidic channel sample mixture 728, and third fluidic channel sample mixture 730 into junctions 722a, 722b, and 722c, respectively. As the sample mixtures and assay units mix in junctions 722a, 722b, and 722c, reaction units are created and pushed downstream towards the amplification region of each fluidic channel. In step 3, assay units and sample mixtures are alternatively pushed until all of each sample mixture has been used to create reaction units, which, in FIG. 7, is three reaction units per fluidic channel (reaction units 744a, 744b, and 744c in first fluidic channel 706; reaction units 746a, 746b, and 746c in second fluidic channel 708; and reaction units 748a, 748b, and 748c in third fluidic channel 710). In step 4, occlusion points 724a, 724c, and 724e are opened. The nine reaction units are pushed into the amplification regions of the fluidic channels (not depicted) by carrier pumped in through the second pre-amplification region port of each fluidic channel (not depicted).

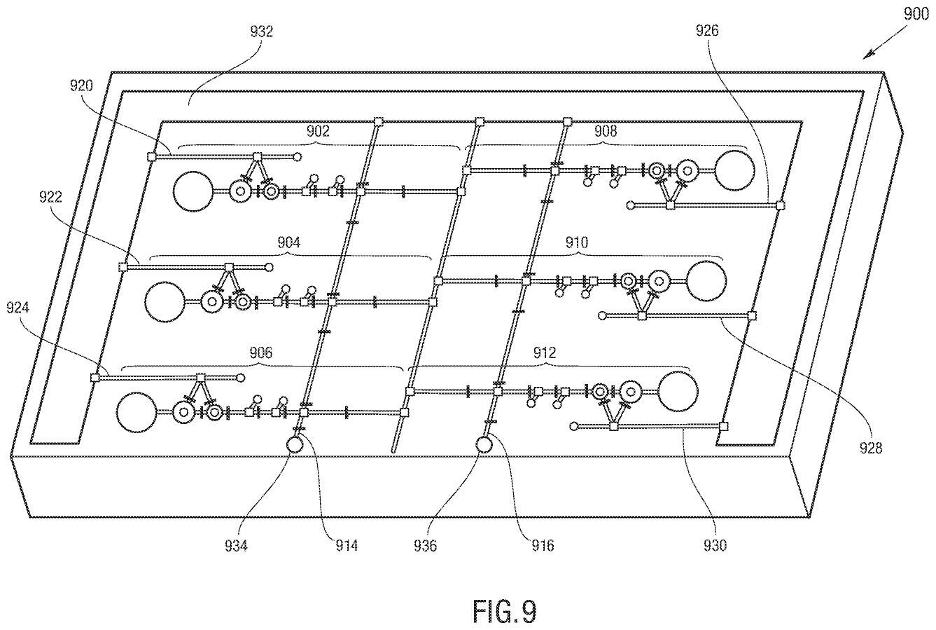

FIG. 9 is a diagram of a six-channel sample cartridge in accordance with aspects of the invention. The sample cartridge 900 is a six-channel sample cartridge comprising a first fluidic channel 902, a second fluidic channel 904, and a third fluidic channel 906, a fourth fluidic channel 908, a fifth fluidic channel 910, and a sixth fluidic channel 912. In this embodiment, the sample cartridge 900 further comprises a first assay line 914, a second assay line 916, a post-amplification waste line 918, a first waste line 920, a second waste line 922, a third waste line 924, a fourth waste line 926, a fifth waste line 928, a sixth waste line 930, and a waste area 932. Each fluidic channel has a waste line that, in this embodiment, connects to waste area 932. In this embodiment, first fluidic channel 902, second fluidic channel 904, and third fluidic channel 906 connect to (share) first assay line 914, and fourth fluidic channel 908, fifth fluidic channel 910, and sixth fluidic channel 912 connect to second assay line 916. In addition, the six fluidic channels connect to post-amplification waste line 918. Each fluidic channel can be connected to the same pump(s) and valve(s) or a different pump(s) and valve(s). First assay line 914 and second assay line 916 can be connected through ports 934 and 936, respectively, to, for example, the same pump and valve or to two different pumps and valves. Pump(s) and valve(s) are not depicted in FIG. 9.

REFERENCE NUMERALS

| | |
|---|---|
| 100 | sample cartridge |
| 102 | fluidic channel |
| 104 | sample chamber |
| 106 | lysis chamber |
| 108 | binding chamber |
| 110 | pre-amplification region |
| 112 | amplification region |
| 114 | assay line |
| 116 | post-amplification waste line |
| 118 | waste line |
| 120 | waste area |
| 122 | sample chamber port |
| 124 | lysis chamber port |
| 126 | binding chamber port |
| 128 | first pre-amplification region port |
| 130 | second pre-amplification region port |
| 132 | assay line port |
| 134 | waste line port |
| 136 | junctions |
| 138 | occlusion points |
| 140 | filter |
| 142 | magnetic bar |
| 144 | beads |
| 146 | nucleic acid binding unit |
| 202 | pump |
| 204 | valve |
| 206 | pump |
| 208 | valve |
| 210 | tube |
| 212 | tube |
| 214 | tube |
| 216 | tube |
| 218 | tube |
| 220 | tube |
| 300 | sample cartridge |
| 302 | first fluidic channel |
| 304 | second fluidic channel |
| 306 | third fluidic channel |
| 308 | assay line |
| 310 | post-amplification waste line |
| 312 | first waste line |
| 314 | second waste line |
| 316 | third waste line |
| 318 | waste area |
| 320 | assay line port |
| 322 | junctions |
| 324 | occlusion points |
| 326 | first fluidic channel sample mixture |
| 328 | second fluidic channel sample mixture |
| 330 | third fluidic channel sample mixture |
| 332 | first assay units |
| 334 | second assay units |
| 336 | third assay units |
| 338 | first fluidic channel reaction units |
| 340 | second fluidic channel reaction units |
| 342 | third fluidic channel reaction units |
| 500 | sample cartridge |
| 502 | pump |
| 504 | valve |
| 506 | first fluidic channel |
| 508 | second fluidic channel |
| 510 | third fluidic channel |
| 512 | first assay line |
| 514 | second assay line |
| 516 | third assay line |
| 518 | first assay line port |
| 520 | second assay line port |
| 522 | third assay line port |
| 524 | tube |
| 526 | tube |
| 528 | tube |
| 530 | junctions |
| 532 | occlusion points |
| 534 | first fluidic channel sample mixture |
| 536 | second fluidic channel sample mixture |
| 538 | third fluidic channel sample mixture |
| 540 | first assay units |
| 542 | second assay units |
| 544 | third assay units |
| 546 | first fluidic channel reaction units |
| 548 | second fluidic channel reaction units |
| 550 | third fluidic channel reaction units |
| 700 | sample cartridge |
| 702 | pump |
| 704 | valve |
| 706 | first fluidic channel |
| 708 | second fluidic channel |
| 710 | third fluidic channel |
| 712 | first assay line |
| 714 | second assay line |
| 716 | third assay line |
| 718 | tube |
| 720 | splitter |
| 722 | junctions |
| 724 | occlusion points |
| 726 | first fluidic channel sample mixture |
| 728 | second fluidic channel sample mixture |
| 730 | third fluidic channel sample mixture |
| 732 | first assay |
| 734 | second assay |
| 736 | third assay |
| 738 | first assay units |
| 740 | second assay units |
| 742 | third assay units |
| 744 | first fluidic channel reaction units |
| 746 | second fluidic channel reaction units |
| 748 | third fluidic channel reaction units |
| 900 | sample cartridge |
| 902 | first fluidic channel |
| 904 | second fluidic channel |
| 906 | third fluidic channel |
| 908 | fourth fluidic channel |
| 910 | fifth fluidic channel |
| 912 | sixth fluidic channel |
| 914 | first assay line |
| 916 | second assay line |
| 918 | post-amplification waste line |
| 920 | first waste line |
| 922 | second waste line |
| 924 | third waste line |
| 926 | fourth waste line |
| 928 | fifth waste line |
| 930 | sixth waste line |
| 932 | waste area |
| 934 | first assay line port |
| 936 | second assay line port |

For clarity, the invention is described under the following headings: “Sample Cartridge,” “Processing a Sample,” “Lysis,” “Binding, Washing, and Eluting,” “Pre-Amplification and Amplification,” “Plungers and Sample Processing Instrument,” and “Multi-Channel and/or Multi-Assay Sample Cartridges.”

### Sample Cartridge

The invention provides sample cartridges for processing samples. The sample cartridges comprise at least one fluidic channel. Each fluidic channel comprises a sample chamber, a lysis chamber, a binding chamber, a pre-amplification region, and an amplification region. The sample cartridges also comprise a waste line that is in fluidic connectivity with each fluidic channel. Each fluidic channel has a dedicated waste line, and therefore the number of waste lines is equivalent to the number of fluidic channels. The sample cartridges optionally comprise at least one assay line that is in fluidic connectivity with the at least one fluidic channel.

The at least one fluidic channel is in fluidic connectivity with at least one pump at, a lysis chamber port, a binding chamber port, a first pre-amplification region port, and a second pre-amplification region port. The at least one waste line is in fluidic connectivity with at least one pump at a waste line port. The optional at least one assay line is in fluidic connectivity with at least one pump at at least one assay line port.

The at least one pump is used to transport fluids (including sample) in a sample cartridge by creating suction and/or pressure. More specifically, the at least one pump is used to transport fluids into, out of, and/or along (through) at least one fluidic channel, at least one waste line, and/or at least one optional assay line. Fluids that are transported include but are not limited to sample, carrier, lysis, wash and elution buffers, master mix, sample mixture, assay, reaction units, and waste. A plurality of plungers is used to occlude at least one fluidic channel, at least one waste line, and/or at least one optional assay line to limit the transport of fluids into, out of, and/or along at least one fluidic channel, at least one waste line, and/or at least one optional assay line by plunging. The plurality of plungers can also be used to transport fluids into, out of, and/or along at least one fluidic channel, at least one waste line, and/or at least one optional assay line by sliding (including rolling).

A sample cartridge comprises a first layer and a second layer coupled together. The first layer and the second layer define the at least one fluidic channel, the at least one waste line, and the optional at least one assay line by a gap(s) between the first layer and the second layer. The gap(s) can be in the first layer, the second layer, or partially in the first layer and partially in the second layer. At least one layer (first or second) is capable of being deformed by a plunger that plunges or slides (including rolls). In preferred embodiments, the first layer is elastomeric (for example, PDMS, polyester, or polypropylene film) and the second layer is rigid (for example, polycarbonate, Cyclo Olefin Polymer (Zeonor), or glass). The layers can be created by a variety of methods including molding, extrusion, and additive manufacturing (3D printing).

A fluidic channel comprises a sample chamber with a volume between 0.25 mL and 25 mL, preferably between 0.5 mL and 5 ml. Each sample cartridge can process a sample with a volume between 0.1 mL and 20 mL, preferably between 0.25 and 5 ml. A sample cartridge can comprise fluids (including, sample, reagents, and assay) that are stored on (including in) the sample cartridge. In some embodiments, all fluids are stored on the sample cartridge. In some embodiments, no fluids are stored on the sample cartridge (and are therefore stored off the sample cartridge), for example, in a container that is part of a sample processing instrument. In some embodiments, some fluids are stored on the sample cartridge (for example, assays) and some fluids are stored off of the sample cartridge (for example, reagents).

Sample cartridges are preferably single-use disposable consumables to prevent contamination and potential exposure to samples comprising pathogens.

### Processing a Sample

A sample is inserted (loaded) into a sample chamber through a sample chamber port. The sample is then transported (using the at least one pump, at least one plunger of the plurality of plungers, and/or at least one additional fluid) to the lysis chamber and lysed to create a lysate. The lysate (lysed sample) is then transported to the binding chamber and bound to a nucleic acid binding unit, washed, and eluted to create an eluate. The eluate (nucleic acid extracted from the sample) is then transported to the pre-amplification region where it is mixed with master mix and assay to create reaction units. The reaction units are then transported to the amplification region where the reaction units are amplified.

During the processing of a sample, a combination of pumping (suction and/or pressure) and plunger plunging and/or sliding (including rolling) is used to transport fluids into, out of, and along (through) a microfluidic channel. For example and in preferred embodiments, lysis buffer is transported into the lysis chamber, waste is transported from the lysis chamber to a waste line, lysate is transported from the lysis chamber to the binding chamber, wash buffer is transported into the binding chamber, waste is transported from the binding chamber to a waste line, elution buffer is transported into the binding chamber, eluate is transported from the binding chamber to the pre-amplification region, master mix and carrier are transported to the pre-amplification region, assay is transported to the pre-amplification region, and reaction units are transported to the amplification region.

### Lysis

Lysis occurs in the lysis chamber. Sample is transported from the sample chamber to the lysis chamber, which contains a filter. The sample is positioned on the upstream side of the filter. The filter is comprised of suitable low-binding membrane materials including but not limited to cellulose acetate, polyethersulfone, polycarbonate, and a combination thereof. The pore size of the membrane is selected so that smaller particles comprising nucleic acids will pass through the filter and larger particles will not. Lysis buffer is pumped in through a lysis buffer port and the sample is lysed. The lysis can occur by any suitable means including but not limited to mechanical, chemical, biological, heat, and acoustic and a combination thereof.

Mechanical lysis involves breaking cells by colliding them with moveable structures. Such moveable structures include but are not limited to bars, beads, rings, plates, and any combination thereof. The moveable structures can be moved by any suitable means including but not limited to magnetism and stirring. If the moveable structures are magnetic, for example magnetic beads, then a magnetic field needs to be generated to move the magnetic moveable structures. For example, magnetic beads can be used to mechanically lyse cells in a sample by exposing the magnetic beads to a changing or moving magnetic field. The collisions between the magnetic beads and the cells causes the cell membranes to break. At least one moveable structure can be in the lysis chamber prior to the introduction of a sample, can be introduced with the sample, or can be loaded into the lysis chamber after the cells have been introduced, or a combination thereof. In a preferred embodiment, the magnetic field is generated by a magnetic field device, for example an electromagnet, on the sample processing instrument. Moveable structures can also be moved by stirring, which can be generated by any suitable means including but not limited to a magnetic stirrer, for example a magnetic stir bar, or a mechanical stirrer (stirring device), for example a vortexer or propeller. For example, a magnetic stir bar can be used to cause the moveable structures, which can be magnetic or non-magnetic, to move and thereby collide with and break cells that are present in the sample. If a magnetic field is used, either to move magnetic structures directly or to control a magnetic stirrer, at least one magnetic field device needs to be on the sample preparation cartridge or a part of the sample processing instrument. If at least one magnetic field device is a part of the sample processing instrument, then the sample preparation cartridge needs to be brought into close enough proximity with the at least one magnetic field device to allow for magnetic connectivity between the at least one magnetic field device and the magnetic structures and/or magnetic stirrer.

Chemical lysis uses at least one chemical compound to break cell membranes. Suitable chemical compounds include but are not limited to detergents, for example sodium dodecyl sulfate (SDS) and cetyl trimethyl ammonium bromide (CTAB), and chaotropes, for example guanidine salts. At least one chemical lysing compound can be in the lysis chamber prior to the introduction of a sample, can be introduced with the sample, or can be loaded into the lysis chamber after the cells have been introduced, or a combination thereof.

Biological lysis uses at least one biological compound to break cell membranes. Suitable biological compounds include but are not limited to enzymes for example proteases, lyticases, lysozymes, and labiase. At least one biological lysing compound can be in the lysis chamber prior to the introduction of a sample, can be introduced with the sample, or can be loaded into the lysis chamber after the cells have been introduced, or a combination thereof.

Heat lysis uses heat to break cell membranes. The cell membranes can be heated by any suitable means including conduction, convection, and/or radiation. Heat is generated by a heating device, preferable an electric heating device such as an electric heating element or Peltier heater. The electric heating device can be attached to the sample preparation cartridge or can be on the sample processing instrument. If the electric heating device is part of the sample processing instrument, then the sample preparation cartridge needs to be brought into close enough proximity with the heating device to allow for sufficient heat transfer via convection, conduction, and/or radiation. Heat can also be generated by an exothermic chemical reaction. U.S. Published Patent Application No. 2006/0115873, hereby incorporated by reference in its entirety, discloses exothermic chemical reactions for cell lysis. In the case of an exothermic chemical reaction, the necessary reagents can be in the lysis chamber prior to the introduction of a sample, can be introduced with the sample, or can be loaded into the lysis chamber after the cells have been introduced, or a combination thereof.

Acoustic lysis uses ultrasound (high frequency) energy waves to break cell membranes. An acoustic wave device (sonicator) can be on the sample preparation cartridge or, preferably, a part of the sample processing instrument. If an acoustic wave device is a part of the sample processing instrument, then the sample preparation cartridge needs to be brought into close enough proximity with the acoustic wave device to allow for sufficient acoustic exposure of cells in a sample. U.S. Pat. No. 9,096,823, hereby incorporated by reference in its entirety, discloses acoustic wave devices for cell lysis.

### Binding, Washing, and Eluting

Binding, washing, and eluting occur in the binding chamber. Sample (lysate) is transported from the lysis chamber to the binding chamber. The sample (eluate) is then transported to the pre-amplification region.

### Pre-Amplification and Amplification

Sample (eluate) is transported from the binding chamber to the pre-amplification region where it is mixed with carrier, reagents (for example, master mix), and assay to create at least one reaction unit. The at least one reaction unit is transported from the pre-amplification region to the amplification region for amplification. For amplification reactions that require heating and/or cooling (for example, thermocycling), sample cartridges preferably interface with a sample processing instrument comprising heating and/or cooling components.

### Plungers

A plurality of plungers is capable of occluding (including reversibly occluding) at least one fluidic channel, at least one waste line, and/or at least one optional assay line to limit the transport of fluids into, out of, and/or along at least one fluidic channel by plunging. The plurality of plungers can also be used to transport fluids into, out of, and/or along (through) at least one fluidic channel, at least one waste line, and/or at least one optional assay line by sliding (including rolling). An occlusion point is the point (location) where a plunger of the plurality of plungers plunges and/or begins to slide (roll). An occlusion point can be located anywhere on a fluidic channel, assay line, or waste line, including at a junction.

A plunger can be made of any material that can deform a layer of a sample cartridge to occlude at least one of a fluidic channel, an assay line, and a waste line. For example, a plunger can be made of plastic, metal, carbon fiber, wood, or porcelain. A plunger can be any shape including but not limited to a rod, piston, pin, plate, disk, ball, wheel, and any combination thereof. The plurality of plungers can be actuated (to plunge and/or slide) by any means including but not limited to fluidic (pressure and/or suction), electric, magnetic, electromagnetic, radiation, mechanical, and any combination thereof.

### Sample Processing Instrument

A sample cartridge can be processed by a sample processing instrument, such as a sample identification instrument. A sample identification instrument can use any means of identifying the nucleic acids in a sample including but not limited to polymerase chain reaction (PCR), fluorescence in situ hybridization (FISH), arrays, and sequencing.

A sample cartridge can be designed to be in fluidic connectivity with a sample processing instrument including before, during, and/or after sample processing. Any sample processing method that requires external components, for example an outside magnetic field device, is preferably incorporated into the sample processing instrument. The sample cartridge and sample processing instrument are designed to allow for operable connectivity between the external sample processing components and the internal sample processing components and/or the sample. For example, an external heating device incorporated into a sample processing instrument needs to be in thermal connectivity with a sample in a lysis chamber to lyse the sample using heat. For an additional example, an external magnetic field device incorporated into a sample processing instrument needs to be in magnetic connectivity with magnetic beads in a lysis chamber to lyse the sample using mechanical lysis. External sample processing components that are preferably incorporated into a sample processing instrument include but are not limited to a plurality of plungers, a heating device, a magnetic field device, and an acoustic wave device.

### Multi-Channel and/or Multi-Assay Sample Cartridges

The invention provides multi-channel sample cartridges (sample cartridges comprising at least two fluidic channels). A multi-channel sample cartridge can have 2, 3, 4, 5, 6, 7, 8, 9, 10, 11, 12, 13, 14, 15, 16, 17, 18, 19, 20, 21, 22, 23, 24, 25, 26, 27, 28, 29, 30, 40, 50, 60, 70, 80, 90, 100, 200 or more fluidic channels, preferably between 2 and 96 fluidic channels. Multi-channel sample cartridges are capable of processing (running) samples in parallel meaning that at least two samples can be processed (each in a different fluidic channel) simultaneously. For example, a sample cartridge with three fluidic channels is capable of simultaneously processing a first sample in a first fluidic channel, a second sample in a second fluidic channel, and a third sample in a third fluidic channel. A multi-channel sample cartridge can process 2, 3, 4, 5, 6, 7, 8, 9, 10, 11, 12, 13, 14, 15, 16, 17, 18, 19, 20, 21, 22, 23, 24, 25, 26, 27, 28, 29, 30, 40, 50, 60, 70, 80, 90, 100, 200 or more samples simultaneously. In addition, two or more fluidic channels are capable of processing the same sample with the same assay(s) or a different assay(s).

Multi-channel sample cartridges have a dedicated waste line for each fluidic channel. In preferred embodiments, each waste lines connect to at least one waste area, so that waste can be transported to the at least one waste area.

Each fluidic channel can process a sample with multiple assays. A fluidic channel can process a sample with 2, 3, 4, 5, 6, 7, 8, 9, 10, 11, 12, 13, 14, 15, 16, 17, 18, 19, 20, 21, 22, 23, 24, 25, 26, 27, 28, 29, 30, 40, 50, 60, 70, 80, 90, 100, or more assays. Each assay can be transported to the pre-amplification region (for reaction unit creation) using the same or a different assay line. In some embodiments, each fluidic channel has a dedicated assay line.

When multiple assays are used with a multi-channel sample cartridge, the assays can be delivered in serial to each fluidic channel using a shared assay line, in parallel to each fluidic channel using dedicated assay lines, or a combination thereof. A combination of tubing, valves manifolds, and/or splitters can be used to deliver the assays to each fluidic channel of the sample cartridge.

In some embodiments, one or more reagents and/or one or more assays are deposited in a sample preparation cartridge prior to processing a sample(s). For example, an assay can be lyophilized and deposited in a fluidic channel downstream from the second pre-amplification region port and upstream from the amplification region. In some embodiments, an assay line is not needed because the assay(s) is already in the fluidic channel(s).

A person having ordinary skill in the art will understand that a variety of configurations of pump(s) (and optionally valve(s)) can be used with a sample cartridge.

### REFERENCES

The list of references below may not be exhaustive and other references may be found throughout the specification.
Herzer, S. (2001). “DNA Purification” in Gerstein, A. S. (ed.) Molecular Biology Problem Solver: A Laboratory Guide. Wiley, pp. 167-195.
Ruggieri, J., Kemp, R., Forman, S., and Van Eden, M. E (2016). “Techniques for Nucleic Acid Purification from Plant, Animal, and Microbial Samples” in Micic, M. (ed.) Sample Preparation techniques for Soil, Plant, and Animal Samples. Humana Press, pp. 41-52.

What is claimed is:

1. A sample cartridge, comprising:
a first layer;
a second layer coupled to the first layer;
at least two fluidic channels defined by the first layer and the second layer, each fluidic channel comprising:
a sample chamber comprising a sample chamber port;
a lysis chamber downstream from the sample chamber, comprising:
a filter;
a lysis chamber port upstream from the filter; and
a means for lysing upstream from the filter;
a binding chamber downstream from the lysis chamber, comprising:
a nucleic acid binding unit; and
a binding chamber port upstream from the nucleic acid binding unit;
a pre-amplification region downstream from the binding chamber, comprising:
a first pre-amplification region port; and
a second pre-amplification region port downstream from the first pre-amplification region port; and
an amplification region downstream from the pre-amplification region; and
a waste line for each fluidic channel, wherein each waste line is defined by the first layer and the second layer, each waste line is in fluidic connectivity with the lysis chamber and the binding chamber of a fluidic channel, and each waste line has a waste line port; and
wherein a plurality of plungers is capable of deforming the first layer to occlude at least one of a fluidic channel and a waste line.

2. The sample cartridge of claim 1, wherein the sample comprises nucleic acids.

3. The sample cartridge of claim 1, wherein the first layer is elastomeric and the second layer is rigid.

4. The sample cartridge of claim 1, wherein the means for lysing is at least one moveable structure.

5. The sample cartridge of claim 4, wherein the at least one moveable structure is magnetic.

6. The sample cartridge of claim 1, wherein each fluidic channel is capable of processing a sample with a volume between 0.1 mL and 20 mL.

7. The sample cartridge of claim 1, wherein each fluidic channel has a sample chamber with a volume between 0.25 mL and 25 mL.

8. The sample cartridge of claim 1, wherein the plurality of plungers is capable of deforming the first layer by at least one of plunging, sliding, and rolling.

9. The sample cartridge of claim 1, wherein the number of fluidic channels is between two and ninety-six.

10. The sample cartridge of claim 1, wherein the sample cartridge is capable of using at least two reagents and at least one of the reagents is not stored on the sample cartridge.

11. The sample cartridge of claim 10, wherein all of the reagents are not stored on the sample cartridge.

12. The sample cartridge of claim 1, wherein the sample cartridge is capable of using at least two reagents and at least one of the reagents is deposited in at least one of the pre-amplification region and the amplification region.

13. The sample cartridge of claim 1, wherein the sample cartridge generates waste from the processing of a sample and wherein the waste does not exit the sample cartridge.

14. The sample cartridge of claim 1, wherein the sample cartridge is capable of interfacing with a sample processing instrument comprising the plurality of plungers.

15. A sample cartridge, comprising:
a first layer;
a second layer coupled to the first layer;
at least two fluidic channels defined by the first layer and the second layer, each fluidic channel comprising:
a sample chamber comprising a sample chamber port;
a lysis chamber downstream from the sample chamber, comprising:
a filter;
a lysis chamber port upstream from the filter; and
a means for lysing upstream from the filter;
a binding chamber downstream from the lysis chamber, comprising:
a nucleic acid binding unit; and
a binding chamber port upstream from the nucleic acid binding unit;
a pre-amplification region downstream from the binding chamber, comprising:
a first pre-amplification region port; and
a second pre-amplification region port downstream from the first pre-amplification region port; and
an amplification region downstream from the pre-amplification region;
at least one assay line defined by the first layer and the second layer and wherein the at least one assay line is in fluidic connectivity with at least one fluidic channel and wherein the at least one assay line is downstream from the second pre-amplification region port and upstream from the amplification region of the at least one fluidic channel; and
a waste line for each fluidic channel, wherein each waste line is defined by the first layer and the second layer, each waste line is in fluidic connectivity with the lysis chamber and the binding chamber of a fluidic channel, and each waste line has a waste line port; and
wherein a plurality of plungers is capable of deforming the first layer to occlude at least one of a fluidic channel, an assay line, and a waste line.

16. The sample cartridge of claim 15, wherein the sample comprises nucleic acids.

17. The sample cartridge of claim 15, wherein the first layer is elastomeric and the second layer is rigid.

18. The sample cartridge of claim 15, wherein the means for lysing is at least one moveable structure.

19. The sample cartridge of claim 18, wherein the at least one moveable structure is magnetic.

20. The sample cartridge of claim 15, wherein each fluidic channel is capable of processing a sample with a volume between 0.1 mL and 20 mL.

21. The sample cartridge of claim 15, wherein each fluidic channel has a sample chamber with a volume between 0.25 mL and 25 mL.

22. The sample cartridge of claim 15, wherein the plurality of plungers is capable of deforming the first layer by at least one of plunging, sliding, and rolling.

23. The sample cartridge of claim 15, wherein the number of fluidic channels is between two and ninety-six.

24. The sample cartridge of claim 15, wherein the sample cartridge is capable of using at least two reagents and at least one of the reagents is not stored on the sample cartridge.

25. The sample cartridge of claim 24, wherein all of the reagents are not stored on the sample cartridge.

26. The sample cartridge of claim 15, wherein the sample cartridge is capable of using at least two reagents and at least one of the reagents is deposited in at least one of the pre-amplification region and the amplification region.

27. The sample cartridge of claim 15, wherein the number of assay lines is one.

28. The sample cartridge of claim 15, wherein the number of assay lines is equivalent to the number of fluidic channels and wherein each assay line is in fluidic connectivity with a valve.

29. The sample cartridge of claim 15, wherein at least two assay lines are in fluidic connectivity with a valve and wherein a splitter is between the at least two assay lines and the valve.

30. The sample cartridge of claim 15, wherein the number of assay lines is equivalent to the number of assays.

31. The sample cartridge of claim 15, wherein the number of assay lines is equivalent to the number of fluidic channels multiplied by the number of assays.

32. The sample cartridge of claim 15, wherein the sample cartridge generates waste from the processing of a sample and wherein the waste does not exit the sample cartridge.

33. The sample cartridge of claim 15, wherein the sample cartridge is capable of interfacing with a sample processing instrument comprising the plurality of plungers.
